(19) United States
(12) Patent Application Publication
(10) Pub. No.: US 2026/0116461 A1
(43) Pub. Date: Apr. 30, 2026

(54) TIRE PARAMETERS-INDEPENDENT CONTROL FOR VEHICLE POWER STEERING SYSTEM

(71) Applicant: FCA US LLC, Auburn Hills, MI (US)

(72) Inventors: Lubna A Khasawneh, Auburn Hills, MI (US); Michele Polignano, Torino (IT)

(21) Appl. No.: 18/932,785

(22) Filed: Oct. 31, 2024

(51) Int. Cl. B62D 5/04; B62D 6/00

(52) U.S. Cl. CPC B62D 5/046; B62D 5/0421; B62D 6/002

(57) ABSTRACT

A method for controlling a steering actuator in a vehicle includes determining a pinion angle, a pinion angular velocity and a pinion torque, using a sliding mode observer model to determine a self-aligning moment as a function of the pinion angle, the pinion angular velocity and the pinion torque, and commanding a steering actuator to provide an output torque as a function of the determined self-aligning moment.

### FIELD

The present disclosure relates to a vehicle power steering system.

### BACKGROUND

Electric power steering systems use an electric motor actuator to drive a vehicle steering system and change the steering angle. The torque needed to be provided from the actuator to the steering system varies at different speeds and to achieve different rates of steering angle change. Further, tires have a self-aligning moment or torque that tends to keep the tires rotating in their current direction and this must be compensated for in order to achieve a desired steering angle change. The self-aligning moment is dependent on a number of parameters relating to the tires, and these tire parameters take time and effort to determine in empirical studies. Once known, the parameters are used in testing a steering control system for a specific vehicle model to compensate for the self-aligning torque and determine other control parameters needed for accurate steering system control. This must be done for each vehicle model and each type of tire. Further, if different tires are put on a vehicle, which may happen after a set of tires wears out and is replaced, the vehicle steering system is then not properly set up to control the steering system in view of the different self-aligning moment of the new tires.

### SUMMARY

In at least some implementations, a method for controlling a steering actuator in a vehicle includes determining a pinion angle, a pinion angular velocity and a pinion torque, using a sliding mode observer model to determine a self-aligning moment as a function of the pinion angle, the pinion angular velocity and the pinion torque, and commanding a steering actuator to provide an output torque as a function of the determined self-aligning moment.

In at least some implementations, the sliding mode observer model also determines an estimated state vector, and the output torque is determined as a function of the estimated state vector. In at least some implementations, the sliding mode observer model also determines a coulomb friction constant, and the output torque is determined as a function of the coulomb friction constant.

In at least some implementations, the sliding mode observer model includes:
choosing variables Aₐ & B_{b} such that Aₐx+B_{b}u approximates the unknown f(x, u);
choosing the optimal observer gains

$$L = [ \begin{matrix}{l}_{1} \\ {l}_{2}\end{matrix} ]$$

using optimal observer theory;
defining the difference between Aₐx+B_{b}u and f(x, u) as D(x, u)≙f(x, u)−Aₐx−B_{b}u and estimating it by a sliding mode correction factor ‘s’;
choosing positive definitive design matrix ‘Q’ and then determining ‘P’ the Lyapunov equation

$${A}_{o}^{T} P + P {A}_{o} = - Q ,$$

where Aₒ Is a stable matrix given by Aₒ=Aₐ−LC;
choosing ρ by first guessing a function h(x, u) to satisfy D(x, u)=P⁻¹C^{T}h(x, u) and its bound ∥h(x, u)∥<h̅, and then setting ρ>h̅;
formulating an observer \hat{x}=Aₐ\hat{x}+B_{b}u+L(y−C\hat{x})+s;
computing the sliding mode correction term as s=ρP⁻¹C^{T} sign(e_{y}); and
estimating D(x, u) as D(x, u)≈E[s].

In at least some implementations,

$$E ( s ) \approx \frac{I}{s τ + 1} s .$$

In at least some implementations, the steering actuator is operable to change a steering angle of tires of a vehicle, and wherein parameters regarding the tires of the vehicle are not known. In at least some implementations, the parameters include one or more of an equivalent moment of inertia, an equivalent damping, and the Coulomb friction torque. In at least some implementations, the parameters include an equivalent moment of inertia, an equivalent damping, and the Coulomb friction torque.

In at least some implementations, the steering model includes a linear part represented by:

$$A x + B u = + {\underbrace{[ \begin{matrix}0 & 1 \\ 0 & - \frac{b}{J}\end{matrix} ]}}_{A} {\underbrace{[ \begin{matrix}{θ}_{p} \\ {\dot{θ}}_{p}\end{matrix} ]}}_{x} + {\underbrace{[ \begin{matrix}0 \\ \frac{1}{J}\end{matrix} ]}}_{B} {\underbrace{{τ}_{p}}}_{u} ,$$

and a nonlinear part represented by:

$$D w = - [ \begin{matrix}0 \\ \frac{F}{J} sgn ( {\dot{θ}}_{p} )\end{matrix} ] - [ \begin{matrix}0 \\ \frac{1}{J}\end{matrix} ] {τ}_{a} ,$$

where θₚ is the pinion angle, \dot{θ}ₚ is the pinion angular velocity; τₚ is the pinion torque, τₐ is the aligning moment, J is the equivalent moment of inertia, b is the equivalent damping, F is the Coulomb friction torque,

$$x = [ \begin{matrix}{x}_{1} \\ {x}_{2}\end{matrix} ] = [ \begin{matrix}{θ}_{p} \\ {\dot{θ}}_{p}\end{matrix} ] ,$$

and u=τₚ is the control input.

In at least some implementations, a method for controlling a steering actuator in a vehicle, includes determining a pinion angle, a pinion angular velocity and a pinion torque, using a sliding mode observer model to determine: a) a self-aligning moment; b) an estimated state vector; and c) a coulomb friction torque, as a function of the pinion angle, the pinion angular velocity and the pinion torque, and commanding a steering actuator to provide an output torque as a function of the determined self-aligning moment. The sliding mode observer model includes: 1) choosing variables Aₐ & B_{b} such that Aₐx+B_{b}u approximates the unknown f(x, u); 2) choosing the optimal observer gains

$$L = [ \begin{matrix}{l}_{1} \\ {l}_{2}\end{matrix} ]$$

using optimal observer theory; 3) defining the difference between Aₐx+B_{b}u and f(x, u) as D(x, u)≙f(x, u)−Aₐx−B_{b}u and estimating it by a sliding mode correction factor ‘s’; 4) choosing positive definitive design matrix ‘Q’ and then determining ‘P’ the Lyapunov equation

$${A}_{o}^{T} P + P {A}_{o} = - Q ,$$

where Aₒ Is a stable matrix given by Aₒ=Aₐ−LC; 5) choosing ρ by first guessing a function h(x, u) to satisfy D(x, u)=P⁻¹C^{T}h(x, u) and its bound ∥h(x, u)∥<h̅, and then setting ρ>h̅; 6) formulating an observer \hat{x}=Aₐ\hat{x}+B_{b}u+L(y−C\hat{x})+s; 7) computing the sliding mode correction term as s=ρP⁻¹C^{T} sign(e_{y}); and 8) estimating D(x, u) as D(x, u)≈E[s].

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle steering system;

FIG. 2 is a schematic diagram of a steering control system;

FIG. 3 is schematic diagram of a sliding mode observer model used in the steering control system;

FIG. 4 is a flowchart of a steering control method; and

FIG. 5 is flowchart for a method of estimating a self-aligning moment for use by a steering controller.

### DETAILED DESCRIPTION

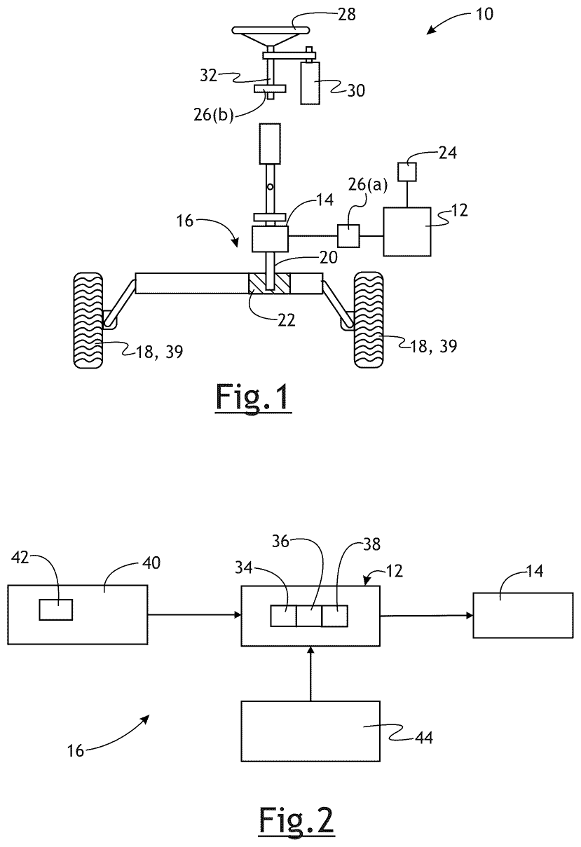

Referring in more detail to the drawings, FIG. 1 illustrates a vehicle electric power steering system 10 used to vary and control the direction of travel of the vehicle. The steering system 10 includes a steering controller 12, a steering actuator 14 such as an electric motor, and a steering assembly 16. The steering actuator 14 is coupled to and driven by the controller 12 and has an output that drives the steering assembly 16 to control the steering angle of the vehicle. The steering assembly 16 may include any desired linkage or system for changing the steering angle of the wheels 18, such as but not limited to a rack and pinion system where the steering actuator 14 is coupled to and drives the pinion 20 that in turn drives the rack 22. The steering system 10 may further include a vehicle speed sensor 24 and a steering angle sensor 26 that are communicated with the steering controller 12 that includes programming to control operation of the steering actuator. The steering angle sensor 26a may detect an actual angle of one or more wheels 18 and act as an actual or output steering angle sensor.

In at least some implementations, the steering system 10 includes a steering input 28, such as a steering wheel, by which a driver can manually change the steering angle of the vehicle to turn the vehicle. A feedback actuator 30 may be provided to create some resistance to rotation of the steering wheel 28, to improve the steering “feel” and improve control of the vehicle. In addition to or instead of the steering input 28, vehicle steering can be managed by a controller, which may be the steering controller 12 or a different controller, such as in autonomous and semi-autonomous vehicle operation. In such systems, a controller 12 determines the desired vehicle direction of travel and controls the steering system to achieve the desired direction of travel, without requiring driver actuation of a steering input 28.

The steering system 10 may be a so-called drive by wire system in which the steering input 12 (e.g. steering wheel) is not directly mechanically coupled to the vehicle wheels 18. As shown in FIG. 1, the steering input 28 and the feedback actuator 30 may be coupled to a steering shaft 32 which is not directly mechanically linked to the steering assembly 16. Instead, the steering input 28 is electronically coupled to the controller 12 which is responsive to movement of the steering input 28 to determine an intended steering angle and which drives the steering actuator 14 to change the vehicle steering angle accordingly. The actual steering angle change can be determined by the steering angle sensor 26 which can be used as feedback by the controller 12 to ensure that the intended steering angle change(s) is/are achieved.

More than one steering angle sensor 26 may be used. For example, an input steering angle sensor 26b may be used to detect rotation of the steering input 28, and for example, may be associated with the steering shaft 32 and responsive to rotation of the steering shaft 32. The output steering angle sensor 26a may be used to determine an actual vehicle steering angle, and may for example, be associated with a vehicle wheel 18 or the steering assembly 16 and responsive to movement of such components to determine the vehicle steering angle. Additional steering angle sensors may be used, for example, to determine steering angles or movement of other components, to provide redundant determinations to ensure sensors are functioning properly or for other reasons.

In order to perform the functions and desired processing set forth herein, as well as the computations therefore, the steering controller/control system 12 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing. For example, the control system 12 may include input signal processing and filtering to enable accurate sampling and conversion or acquisitions of signals from the sensors (e.g. steering angle sensor 26). As used herein the term control system or controller 12 may refer to one or more processing circuits such as an application specific integrated circuit (ASIC), an electronic circuit, a processor (shared, dedicated, or group), generally referred to by reference numeral 34 in FIG. 2) and memory 36 that executes one or more software or firmware programs 38, a combinational logic circuit, and/or other suitable components that provide the described functionality. The control system 12 may be distributed among different vehicle modules, such as a steering control module, an infotainment system control module, engine control module or unit, powertrain control module, transmission control module, and the like.

The term “memory” 36 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

As the vehicle is moving and the wheels 18 are rotating, a self-aligning moment results from force on the tire 39 and this moment resists rotation of the wheels 18 to change the steering angle of the vehicle. That is, the self-aligning moment tends to keep the vehicle moving relatively straight (e.g. its current direction) and resists steering effort. To overcome this, a significant torque must be provided to the steering assembly 16 by the actuator 14 to change the vehicle steering angle/direction of travel. Controlling the actuator 14 to provide a force sufficient to overcome the self-aligning moment requires that the force be accurately estimated to avoid too little or too much input by the steering actuator 14 to the steering system 16.

The self-aligning torque may be given by the following equation: τₐ=(tₚ+tₘ)F_{yf}. If the Pacejca tire model is used, the later forces can be computed as: F_{yf}=D sin(C arctan(Bα_{f}−E(Bα_{f}−arctan(Bα_{f})))); and the pneumatic trail can be computed as: tₚ=D cos(C arctan(Bα_{f}−E(Bα_{f}−arctan(Bα_{f})))). In this analysis, the parameters C, D, B and E represent the shape factor, peak factor, stiffness factor and curvature factor, respectively. These parameters can be computed as functions of normal force and other tire parameters noted as a₁-a₈, as: C=2.4; D=a₁F_{z}²+a₂F_{z};

$$B = \frac{{a}_{3} {{F}_{z}}^{2} + {a}_{4} {F}_{z}}{{e}^{{a}_{5} {F}_{z}} CD} ;$$

and E=a₆F_{z}²+a₇F_{z}+a₈, where a₁ is the load influence on the longitudinal friction coefficient (*1000); a₂ is the longitudinal friction coefficient (*1000); a₃ is the curvature factor of stiffness/load; a₄ is the change of stiffness with slip; a₅ is the change of progressivity of stiffness/load; a₆ is the curvature change with load\hat{ }2; a₇ is the curvature change with load; and as is the curvature factor.

When tire parameters are known, the self-aligning moment can be estimated, but actual tire 39 and vehicle testing is required. The needed tire parameters usually are determined experimentally by the tire manufacturer by a time-consuming and costly process that requires special vehicle settings and testing on a test track. And the parameters are different from one tire to another so separate testing for each model of tire is needed. With tire parameters and other system parameters known except for the self-aligning moment, a vehicle steering system could be actuated during a test (e.g. with the vehicle on a hoist so the vehicle is not moving and the effect of self-aligning torque is eliminated), data collected and then an estimation performed to determine the EPS internal parameters. Doing so provided information for estimation of, for example, an equivalent moment of inertia, an equivalent damping, and the Coulomb friction torque, and ultimately the self-aligning moment. This testing, data collection and estimation process is time-consuming and is needed for each vehicle, for changes in the actuators or other system components in a vehicle including different tire models, etc.

With the known parameters and testing/data collection, vehicles could include controllers with programming designed to compensate for the self-aligning moment of the tires 39 provided with the new vehicle. However, even then, the tires on a vehicle can be changed and changing to tires that have different characteristics (e.g. diameter, width, hardness/friction properties, tread shapes or types, etc.) changes the self-aligning torque and interferes with and degrades control of the steering system. In this case, a customer is not able to change the steering controller programming so that it accurately estimates the self-aligning moment of the new tires, and the steering control is negatively affected.

In FIG. 2, an autonomous or partially autonomous vehicle steering system 16 is shown. The steering system includes a trajectory following controller 40 that knows or determines a desired path of travel for the vehicle. The trajectory following controller 40 may utilize, for example, a navigation program 42 with maps and with a destination inputted to enable determination of the roads to be taken along the path of travel. The desired path of travel and steering angles needed to navigate along the path of travel are provided to the steering controller 12 which controls the steering actuator 14 as a function of a self-aligning moment model 44 that provides a self-aligning moment estimation, as described in more detail below.

In at least some implementations of the systems and methods described herein, the tire parameters are treated as unknowns and are accounted for as a disturbance in a torque estimating model 44, and the disturbance is explicitly estimated in a separate observer from the torque estimating model. The estimated disturbance/tire parameters are then used by the torque estimating model to enable the controller 12 to compensate for the self-aligning moment of any tires 39, which can be used to control the steering system 16 in a more controlled and improved manner. This may be done with a sliding mode control system, as noted herein.

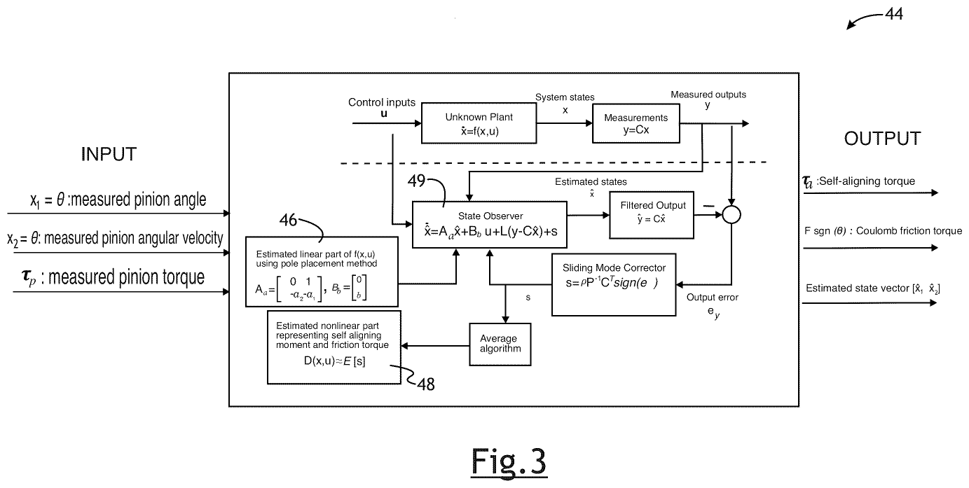

In the new sliding mode observer design, the time-consuming EPS internal parameter estimation described above is avoided. The parameters and the structure of the system are assumed to be unknown and the whole unknown system is estimated only by measuring some signals from sensors. In at least some implementations, these signals include pinion angle, pinion angular velocity, and pinion torque. As shown in FIG. 3, the estimate model can be partitioned to include a linearized part 46 that roughly represents the linear characteristics in the system and a nonlinear part 48 that represents the self-aligning moment and friction torque.

In at least some implementations, the linear part 46 is represented by:

$$Ax + Bu = {\underbrace{[ \begin{matrix}0 & 1 \\ 0 & - \frac{b}{J}\end{matrix} ]}}_{A} {\underbrace{[ \begin{matrix}{θ}_{p} \\ {\dot{θ}}_{p}\end{matrix} ]}}_{x} + {\underbrace{[ \begin{matrix}0 \\ \frac{1}{J}\end{matrix} ]}}_{B} {\underbrace{{τ}_{p}}}_{u} ,$$

and the nonlinear part 48 is represented by:

$$Dw = - [ \begin{matrix}0 \\ \frac{F}{J} sgn ( {\dot{θ}}_{p} )\end{matrix} ] - [ \begin{matrix}0 \\ \frac{1}{J}\end{matrix} ] {τ}_{a} ,$$

which represents the friction torque and self-aligning torque. In the above equations, θₚ is the pinion angle, \dot{θ}ₚ is the pinion angular velocity, τₚ is the pinion torque, τₐ is the aligning moment, J is the equivalent moment of inertia, b is the equivalent damping, and F is the Coulomb friction torque. Here,

$$x = [ \begin{matrix}{x}_{1} \\ {x}_{2}\end{matrix} ] = [ \begin{matrix}{θ}_{p} \\ {\dot{θ}}_{p}\end{matrix} ] ,$$

and u=τₚ is the control input.

In this example, the parameters J, b and F are not known. As a result, A & B, which represent the linear characteristics of the system, are not known. Further, the nonlinear part of the system represented by Dw is also unknown. Based on this, the system can be represented by a nonlinear function: \dot{x}=f(x, u), and y=Cx, where f(x, u) is a bounded nonlinear function whose parameters and structure are generally unknown, and C is a known measurement matrix. The term Aₐx+B_{b}u is used to represent the linear characteristics in f(x, u) and define their difference as an unknown term D(x, u). This difference represents the nonlinear dynamics from the self-aligning torque and friction force: D(x, u)≙f(x, u)−Aₐx−B_{b}u. And by substituting \dot{x} it becomes \dot{x}=Aₐx+B_{b}u+D(x, u).

Variable A, which is approximately equal to Aₐ, can then be estimated as

$${A}_{a} = [ \begin{matrix}0 & 1 \\ - {a}_{2} & - {a}_{1}\end{matrix} ]$$

and B, which is approximately equal to B_{b}, can be estimated as

$${B}_{b} = [ \begin{matrix}0 \\ {b}_{2}\end{matrix} ] ,$$

which results in

$$\dot{x} = [ \begin{matrix}0 & 1 \\ - {a}_{2} & - {a}_{1}\end{matrix} ] [ \begin{matrix}{x}_{1} \\ {x}_{2}\end{matrix} ] - [ \begin{matrix}0 \\ {b}_{2}\end{matrix} ] u ,$$

where a₁ a₂ are chosen such that the characteristic equation of

$$\dot{x} = [ \begin{matrix}0 & 1 \\ - {a}_{2} & - {a}_{1}\end{matrix} ] [ \begin{matrix}{x}_{1} \\ {x}_{2}\end{matrix} ]$$

given by s²+a₁s+a₂ has stable roots using pole placement techniques, and b₂ can be roughly estimated, but should be greater than zero because it represents the control effectiveness.

This leaves the nonlinear part that consists of the self-aligning torque and the friction torque, and the state equation becomes:

$$\dot{x} = [ \begin{matrix}{\dot{x}}_{1} \\ {\dot{x}}_{2}\end{matrix} ] = f ( x , u ) = [ \begin{matrix}{f}_{1} ( {x}_{1 ,} {x}_{2 ,} u ) \\ {f}_{2} ( {x}_{1 ,} {x}_{2 ,} u )\end{matrix} ] \approx {\underbrace{[ \begin{matrix}0 & 1 \\ - {a}_{2} & - {a}_{1}\end{matrix} ] [ \begin{matrix}{x}_{1} \\ {x}_{2}\end{matrix} ] + [ \begin{matrix}0 \\ {b}_{2}\end{matrix} ] u}}_{Estimatednominal linear part} + {\underbrace{D ( x , u )}}_{Unknownnonlinearpart}$$

And the sliding mode observer can be formulated to estimate the unknown nonlinear part D(x, u), which represents the self-aligning torque and friction torque. In this way, the sliding mode observer is estimating both the friction torque and the self-aligning torque, not just the self-aligning torque. The new sliding mode observer equation 49 now becomes:

$$\dot{\hat{x}} = {A}_{a} \hat{x} + {B}_{b} u + L ( y - C \hat{x} ) + s$$

$$($$

$$[ \begin{matrix}{\dot{\hat{x}}}_{1} \\ {\dot{\hat{x}}}_{2}\end{matrix} ] = [ \begin{matrix}0 & 1 \\ - {a}_{1} & - {a}_{2}\end{matrix} ] [ \begin{matrix}{\hat{x}}_{1} \\ {\hat{x}}_{2}\end{matrix} ] + [ \begin{matrix}0 \\ b\end{matrix} ] {τ}_{p} + [ \begin{matrix}{l}_{1} \\ {l}_{2}\end{matrix} ] ( y - [ \begin{matrix}1 & 0\end{matrix} ] [ \begin{matrix}{\hat{x}}_{1} \\ {\hat{x}}_{2}\end{matrix} ] ) + [ \begin{matrix}{s}_{1} \\ {s}_{2}\end{matrix} ]$$

Where ‘s’ is a correction term that is a sliding-mode function to be determined, and is substituted for the unknown Dw.

$$\hat{x} = [ \begin{matrix}{\hat{x}}_{1} \\ {\hat{x}}_{2}\end{matrix} ] ,$$

where \hat{x}₁ is the estimated pinion angle, and \hat{x}₂ is the estimated pinion angular velocity. As represented here, ‘s’ is a vector consisting of elements s1 and s2. s1 is an estimate of zero to keep the matrix dimension stable and s2 represents the estimated disturbance (self-aligning torque and static friction).

As noted in FIG. 3, the average algorithm can be a type of low pass filter, e.g.,

$$Dw = \frac{I}{s τ + 1} s ,$$

where the ‘s’ in the denominator denotes the Laplace operator, not the sliding mode corrector. The sliding mode corrector ‘s’ is given by s=ρP⁻¹C^{T} sign(e_{y}), where ρ is a design parameter, the choice of which affects the accuracy and performance of the estimated disturbance. Using Lyapunov stability theory, where the Lyapunov function represents the energy function of the system, it was shown that ρ should be chosen greater than h̅ to guarantee the negative definiteness of the Lyapunov function derivative. This means that the system is dissipating energy and hence, is stable. With this in mind, h̅ can be solved for first and then ρ>h̅ is chosen, and ‘s’ can be solved for, given that the other terms are known.

In one example, in the observer design, Dw was initially guessed/set at

$$[ \begin{matrix}0 \\ 5\end{matrix} ] [ 1 ] ,$$

with C^{T}=[1 0]′ the following can be computed:

$${P}^{- 1} = [ \begin{matrix}0.0609 & 0.0337 \\ 0.0337 & 0.1706\end{matrix} ] .$$

Then these terms can be substituted into the equation Dw=P⁻¹C^{T}h(w), and h(w) can be solved for as

$$[ \begin{matrix}0 \\ 5\end{matrix} ] [ 1 ] = [ \begin{matrix}0 \\ 5\end{matrix} ] = [ \begin{matrix}0.0609 & 0.0337 \\ 0.0337 & 0.1706\end{matrix} ] [ \begin{matrix}1 \\ 0\end{matrix} ] h ( w ) \leq [ \begin{matrix}0.0609 \\ 0.0337\end{matrix} ] \overline{h} \to [ \begin{matrix}0 \\ 5\end{matrix} ] \leq [ \begin{matrix}0.0609 \\ 0.0337\end{matrix} ] \overline{h} \to \overline{h} \geq 148.37 .$$

ρ was then chosen to be greater than 148.37, for example 200, and then increased or decreased (but not below 148.37) based on the observer response. In the example, ρ was tuned to 350 which resulted in good performance.

Further, In the new design, Optimal observer theory is used to obtain the observer gains [l₁ l₂] using a filter, such as Kalman Bucy filter techniques. The first step is to choose the filter's positive definite symmetric weighting matrices Q_{KB}&R_{KB} such that the pair [Aₐ, \sqrt{Q_{KB}}] is controllable. In at least some implementations, Q_{KB}&R_{KB} are tuned by trial and error. Q_{KB} represents the model uncertainty and R_{KB} represents the sensor noise. Both should be positive definite diagonal matrices, and the entries inside should not have negative values as they represent the variance of the model states (steering angle and steering angular velocity) and sensors (steering angle sensor). R_{KB} is a scalar because one sensor measurement, steering angle, can either be set to 1 in the beginning an then tuned to get the desired response, or it may be obtained from the manufacturer as a starting point.

In one implementation, the final value used for R_{KB} was 0.001, where a smaller value indicates less sensor noise and hence, less variance, and vice versa. Q_{KB} in this example is a 2 by 2 diagonal matrix because there are 2 states

$${Q}_{K B} = [ \begin{matrix}{q}_{{KB}_{11}} & 0 \\ 0 & {q}_{{KB}_{22}}\end{matrix} ]$$

with q_{KB}_{₁₁} representing the variance of the first state (steering angle) and q_{KB}_{₂₂} represent the variance of the second state (steering angular velocity). In at least some implementations, tuning may start from an identity matrix

$${Q}_{K B} = [ \begin{matrix}1 & 0 \\ 0 & 1\end{matrix} ] .$$

In one example, the final tuning used was

$${Q}_{K B} = [ \begin{matrix}0.01 & 0 \\ 0 & 0.01\end{matrix} ] .$$

In general, the range of Q_{KB}&R_{KB} entries is wide, and in at least some implementations they may be within a range of 0.001 to 100,000, where 0.001 indicates a low variance and more trust in the sensor/model, and 100,000 indicates a high variance and less trust in the sensor/model, such as with a very noisy sensor or a fast varying uncertain model state.

The second step is to solve for the positive definite symmetric matrix P_{KB} from the algebraic Ricotti equation given by: AₐP_{KB}+P_{KB}Aₐ^{T}−P_{KB}C^{T}R_{KB}⁻¹CP_{KB}+Q_{KB}=0. Next, the filter gains can be computed from: L=[l₁ l₂]′=P_{KB}C^{T}R_{KB}⁻¹.

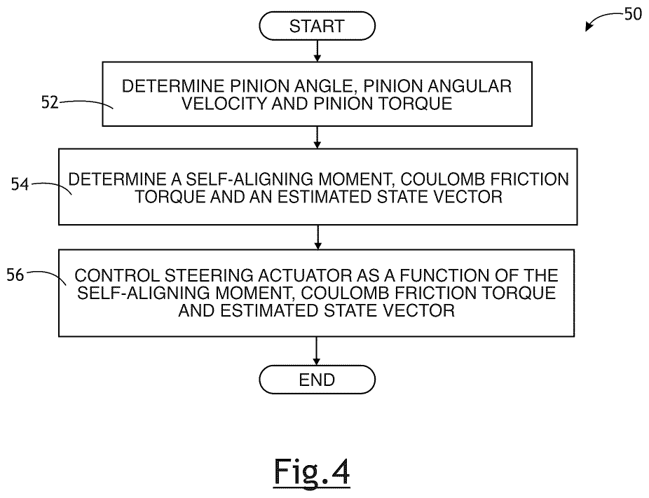

In the method 50 shown in FIG. 4, in step 52, inputs are determined for the pinion angle, pinion angular velocity and pinion torque. In step 54, using a sliding mode observer model as noted herein, the self-aligning moment, coulomb friction torque and an estimated state

$$vector [ \begin{matrix}{\hat{x}}_{1} \\ {\hat{x}}_{2}\end{matrix} ] ,$$

are determined. In step 56, the steering actuator is controlled as a function of the outputs/determinations in step 54 to change the steering angle to the desired steering angle, including compensation for the self-aligning moment. Prior systems used additional inputs including, but not limited to, equivalent moment of inertia, equivalent damping and a coulomb friction constant, and outputted only a self-aligning moment and estimated state vector.

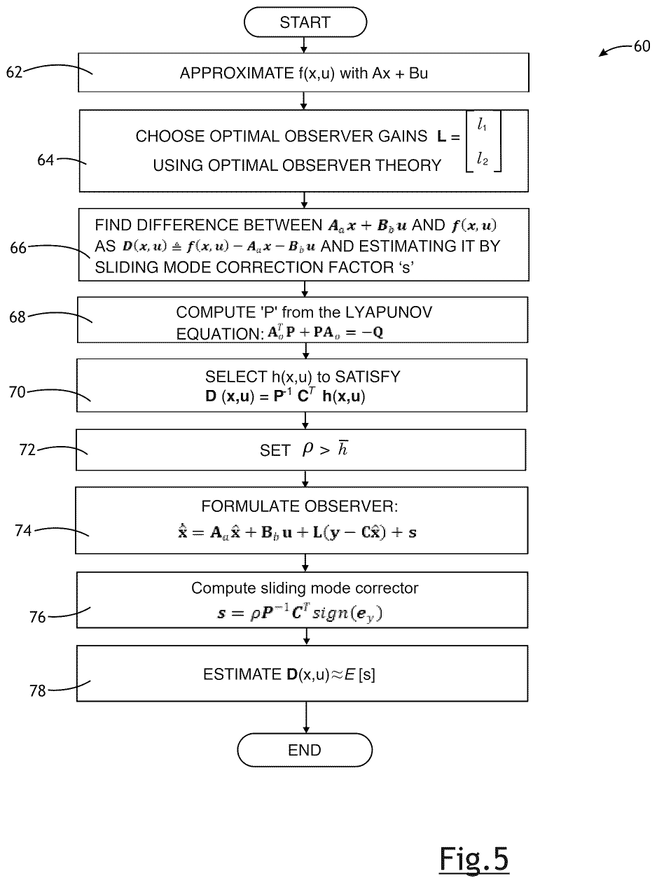

In at least some implementations, the method 60 shown in FIG. 5 may be used in step 54 of FIG. 4, and includes:
1) In step 62, choosing Aₐ & B_{b} such that Aₐx+B_{b}u approximates the unknown f(x, u);
2) In step 64, choosing the optimal observer gains

$$L = [ \begin{matrix}{l}_{1} \\ {l}_{2}\end{matrix} ]$$

using optimal observer theory;
3) In step 66, defining the difference between Aₐx+B_{b}u and f(x, u) as D(x, u)≙f(x, u)−Aₐx−B_{b}u and estimating it by a sliding mode correction factor ‘s’;
4) In step 68, choosing positive definite design matrix ‘Q’ and then computing ‘P’ from the Lyapunov equation Aₒ^{T}P+PAₒ=−Q, where Aₒ is a stable matrix given by Aₒ=Aₐ−LC;
5) In step 70, choosing ρ by first guessing a function h(x, u) to satisfy D(x, u)=P⁻¹C^{T}h(x, u) and its bound ∥h(x, u)∥<h̅, and then in step 72 setting ρ>h̅;
6) In step 74, formulating an observer \hat{x}=Aₐ\hat{x}+B_{b}u+L(y−C\hat{x})+s;
7) In step 76, computing the sliding mode correction term as s=ρP⁻¹C^{T} sign(e_{y}); and
8) In step 78, estimating D(x, u) as

$$D ( x , u ) \approx E ( s ) \approx \frac{I}{s τ + 1} s .$$

Accordingly, the systems and methods described herein can determine the self-aligning moment in a vehicle without knowing the tire parameters, including for example, diameter, width (e.g. tread width), friction properties, and firmness (e.g. nominal air pressure), and the like, from which the equivalent moment of inertia ‘J’, equivalent damping ‘b’, and Coulomb Friction constant ‘F’ are determined. Previous methods required knowledge of tire parameters, which can change not only from tire type to another, but also with tire wear. Previous methods calculate and calibrate the tire self-aligning moment based on the specific tire parameters installed in the vehicle at the time of the design and when the vehicle is new/originally sold. After the vehicle is sold, the customer might change the tires 39 to a different type, and this and tire wear can cause degradation in the self-aligning torque estimate, and as a result will cause degradation in the steering control system.

As noted herein, the tire self-aligning moment can be estimated using advanced observer theory such as a Sliding Mode Observer model, and requires no knowledge of the tire parameters. Thus, tire wear and even replacing the tires 39 in the vehicle to a different tire type will not affect the accuracy and robustness of the self-aligning moment estimate, which ensures consistent behavior of the steering control system. Still further, the systems and methods can work on a wide range of vehicle platforms which facilitates implementing steering system controls in different vehicle models. Additionally, this method can also estimate the steering system state (steering angle, steering angular velocity) in addition to the self-aligning moment in the same observer model design, so no additional observer is needed to estimate the steering system state.

With the sliding mode control, the system can be responsive to larger magnitudes of torque output needed for larger steering angle changes and also enable accurate adjustments for smaller steering angle changes. This can reduce oversteer and understeer commands, and also prevent left and right “porpoising” or “hunting” for the correct steering angle, such as by repeated, smaller oversteering commands, which cause a vehicle to move back and forth between lane lines on a road, or relative to a desired path of travel, rather than in a straighter line along the road or path of travel. The improved controls may be particularly beneficial in autonomous and semi-autonomous driving systems wherein vehicle steering is managed by the steering controller(s) and not by a human driver. The system can be deployed in a wide range of vehicles and can adapt to new vehicles, as well as new components in a vehicle such as new tires, controllers and actuators, and the system can adapt to changed tire characteristics as the tires 39 wear out over time.

What is claimed is:

1. A method for controlling a steering actuator in a vehicle, comprising:
determining a pinion angle, a pinion angular velocity and a pinion torque;
using a sliding mode observer model to determine a self-aligning moment as a function of the pinion angle, the pinion angular velocity and the pinion torque; and
commanding a steering actuator to provide an output torque as a function of the determined self-aligning moment.

2. The method of claim 1 wherein the sliding mode observer model also determines an estimated state vector, and the output torque is determined as a function of the estimated state vector.

3. The method of claim 2 wherein the sliding mode observer model also determines a coulomb friction torque, and the output torque is determined as a function of the coulomb friction torque.

4. The method of claim 1 wherein the sliding mode observer model also determines a coulomb friction torque, and the output torque is determined as a function of the coulomb friction torque.

5. The method of claim 1 wherein the sliding mode observer model includes:
choosing variables Aₐ & B_{b} such that Aₐx+B_{b}u approximates the unknown f(x, u);
choosing the optimal observer gains
$$L = [ \begin{matrix}{l}_{1} \\ {l}_{2}\end{matrix} ]$$
using optimal observer theory;
defining the difference between Aₐx+B_{b}u and f(x, u) as D(x, u)≙f(x, u)−Aₐx−B_{b}u and estimating it by a sliding mode correction factor ‘s’;
choosing positive definitive design matrix ‘Q’ and then determining ‘P’ the Lyapunov equation Aₒ^{T}P+PAₒ=−Q, where Aₒ is a stable matrix given by Aₒ=Aₐ−LC;
choosing ρ by first guessing a function h(x, u) to satisfy D(x, u)=P⁻¹C^{T}h(x, u) and its bound ∥h(x, u)∥<h̅, and then setting ρ>h̅;
formulating an observer \hat{x}=Aₐ\hat{x}+B_{b}u+L(y−C\hat{x})+s;
computing the sliding mode correction term as s=ρP⁻¹C^{T} sign(e_{y}); and
estimating D(x, u) as D(x, u)≈E[s].

6. The method of claim 5 wherein
$$E ( s ) \approx \frac{I}{s τ + 1} s .$$

7. The method of claim 1 wherein the steering actuator is operable to change a steering angle of tires of a vehicle, and wherein parameters regarding the tires of the vehicle are not known.

8. The method of claim 7 wherein the parameters include one or more of an equivalent moment of inertia, an equivalent damping, and the Coulomb friction constant.

9. The method of claim 7 wherein the parameters include an equivalent moment of inertia, an equivalent damping, and the Coulomb friction constant.

10. The method of claim 1 wherein the steering model includes a linear part represented by:
$$Ax + Bu = {\underbrace{[ \begin{matrix}0 & 1 \\ 0 & − \frac{b}{J}\end{matrix} ]}}_{A} {\underbrace{[ \begin{matrix}{θ}_{p} \\ {\dot{θ}}_{p}\end{matrix} ]}}_{x} + {\underbrace{[ \begin{matrix}0 \\ \frac{1}{J}\end{matrix} ]}}_{B} {\underbrace{{τ}_{p}}}_{u} ,$$
and a nonlinear part represented by:
$$Dw = - [ \begin{matrix}0 \\ \frac{F}{J} sgn ( {\dot{θ}}_{p} )\end{matrix} ] - [ \begin{matrix}0 \\ \frac{1}{J}\end{matrix} ] {τ}_{a} ,$$
where θₚ is the pinion angle, \dot{θ}ₚ is the pinion angular velocity; τₚ is the pinion torque, τₐ is the aligning moment, J is the equivalent moment of inertia, b is the equivalent damping, F is the Coulomb friction constant,
$$x = [ \begin{matrix}{x}_{1} \\ {x}_{2}\end{matrix} ] = [ \begin{matrix}{θ}_{p} \\ {\dot{θ}}_{p}\end{matrix} ] ,$$
and u=τₚ is the control input.

11. A method for controlling a steering actuator in a vehicle, comprising:
determining a pinion angle, a pinion angular velocity and a pinion torque;
using a sliding mode observer model to determine: a) a self-aligning moment; b) an estimated state vector; and c) a coulomb friction torque, as a function of the pinion angle, the pinion angular velocity and the pinion torque; and
commanding a steering actuator to provide an output torque as a function of the determined self-aligning moment, wherein the sliding mode observer model includes:
choosing variables Aₐ & B_{b} such that Aₐx+B_{b}u approximates the unknown f(x, u);
choosing the optimal observer gains
$$L = [ \begin{matrix}{l}_{1} \\ {l}_{2}\end{matrix} ]$$
using optimal observer theory;
defining the difference between Aₐx+B_{b}u and f(x, u) as D(x, u)≙f(x, u)−Aₐx−B_{b}u and estimating it by a sliding mode correction factor ‘s’;
choosing positive definitive design matrix ‘Q’ and then determining ‘P’ the Lyapunov equation Aₒ^{T}P+PAₒ=−Q, where Aₒ is a stable matrix given by Aₒ=Aₐ−LC;
choosing ρ by first guessing a function h(x, u) to satisfy D(x, u)=P⁻¹C^{T}h(x, u) and its bound ∥h(x, u)∥<h̅, and then setting ρ>h̅;
formulating an observer \hat{x}=Aₐ\hat{x}+B_{b}u+L(y−C\hat{x})+s;
computing the sliding mode correction term as s=ρP⁻¹C^{T} sign(e_{y}); and
estimating D(x, u) as D(x, u)≈E[s].

12. The method of claim 11 wherein the steering actuator is operable to change a steering angle of tires of a vehicle, and wherein parameters regarding the tires of the vehicle are not known.

13. The method of claim 12 wherein the parameters include one or more of an equivalent moment of inertia, an equivalent damping, and the Coulomb friction constant.

14. The method of claim 12 wherein the parameters include an equivalent moment of inertia, an equivalent damping, and the Coulomb friction constant.

15. The method of claim 11 wherein the steering model includes a linear part represented by:
$$Ax + Bu = {\underbrace{[ \begin{matrix}0 & 1 \\ 0 & − \frac{b}{J}\end{matrix} ]}}_{A} {\underbrace{[ \begin{matrix}{θ}_{p} \\ {\dot{θ}}_{p}\end{matrix} ]}}_{x} + {\underbrace{[ \begin{matrix}0 \\ \frac{1}{J}\end{matrix} ]}}_{B} {\underbrace{{τ}_{p}}}_{u} ,$$
and a nonlinear part represented by:
$$Dw = - [ \begin{matrix}0 \\ \frac{F}{J} sgn ( {\dot{θ}}_{p} )\end{matrix} ] - [ \begin{matrix}0 \\ \frac{1}{J}\end{matrix} ] {τ}_{a} ,$$
where θₚ is the pinion angle, \dot{θ}ₚ is the pinion angular velocity; τₚ is the pinion torque, τₐ is the aligning moment, J is the equivalent moment of inertia, b is the equivalent damping, F is the Coulomb friction constant,
$$x = [ \begin{matrix}{x}_{1} \\ {x}_{2}\end{matrix} ] = [ \begin{matrix}{θ}_{p} \\ {\dot{θ}}_{p}\end{matrix} ] ,$$
and u=τₚ is the control input.
